(19) United States
(12) Patent Application Publication
(10) Pub. No.: US 2012/0183337 A1
(43) Pub. Date: Jul. 19, 2012

(54) FUSER AND IMAGE FORMING APPARATUS

(75) Inventors: Kazutoshi Takahashi, Shizuoka-ken (JP); Satoshi Kinouchi, Tokyo (JP); Shigeru Fujiwara, Kanagawa-ken (JP); Ryota Saeki, Shizouka-ken (JP); Shoko Shimmura, Kanagawa-ken (JP); Toshihiro Sone, Kanagawa-ken (JP); Takafumi Amano, Kanagawa-ken (JP)

(73) Assignees: Toshiba Tec Kabushiki Kaisha, Tokyo (JP); Kabushiki Kaisha Toshiba, Tokyo (JP)

(21) Appl. No.: 13/351,016

(22) Filed: Jan. 16, 2012

Related U.S. Application Data
(60) Provisional application No. 61/434,397, filed on Jan. 19, 2011.

(51) Int. Cl. G03G 15/20

(52) U.S. Cl. 399/329

(57) ABSTRACT

According to one embodiment, a fuser includes a heating roller, an endless belt, and a pressing roller. The heating roller rotates and comes into contact with a toner surface side of a sheet to heat the sheet. The endless belt has hardness lower than the hardness of the heating roller. The pressing roller is an only rotating body provided in a space formed by the endless belt and having an outer diameter smaller than the inner diameter of the endless belt. The pressing roller has hardness lower than the hardness of the heating roller and presses the heating roller via a part of the endless belt.

### CROSS-REFERENCE TO RELATED APPLICATION

This application is based upon and claims the benefit of priority from the prior U.S. Patent Application No. 61/434,397, filed on Jan. 19, 2011, the entire contents of which are incorporated herein by reference.

### FIELD

Embodiments described herein relate generally to a fuser and an image forming apparatus.

### BACKGROUND

In the past, some fuser includes a heating roller and a belt arranged to be wound around a part of the heating roller. The heating roller may also be referred to as fusing roller. Plural rollers are arranged on the inside of the belt. One of the rollers arranged on the inside of the belt is a roller for applying tension to the belt. Two of the rollers arranged on the inside of the belt press the heating roller via the belt. Between the two pressing rollers, a sponge in contact with the inner side of the belt and a spring for pressing the heating roller via the sponge or the like are provided.

With such a configuration, a sheet conveyed to between the heating roller and the belt are heated and pressed and a toner on the sheet is fixed.

However, the fuser having such structure requires a large number of components on the inside of the belt and the structure is complicated.

### DESCRIPTION OF THE DRAWINGS

FIG. 1 is a longitudinal sectional view of an image forming apparatus according to a first embodiment;

FIG. 2 is an enlarged view of the periphery of a photoconductive member in FIG. 1;

FIG. 3 is a longitudinal sectional view of a fuser according to the first embodiment; and

FIG. 4 is a longitudinal sectional view of a fuser according to a second embodiment.

### DETAILED DESCRIPTION

In general, according to one embodiment, there is provided a fuser including: a heating roller; an endless belt; and a pressing roller. The heating roller rotates and comes into contact with a toner surface side of a sheet to heat the sheet. The endless belt has hardness lower than the hardness of the heating roller. The pressing roller is an only rotating body provided in a space formed by the endless belt and having an outer diameter smaller than the inner diameter of the endless belt. The pressing roller has hardness lower than the hardness of the heating roller and presses the heating roller via a part of the endless belt.

### First Embodiment

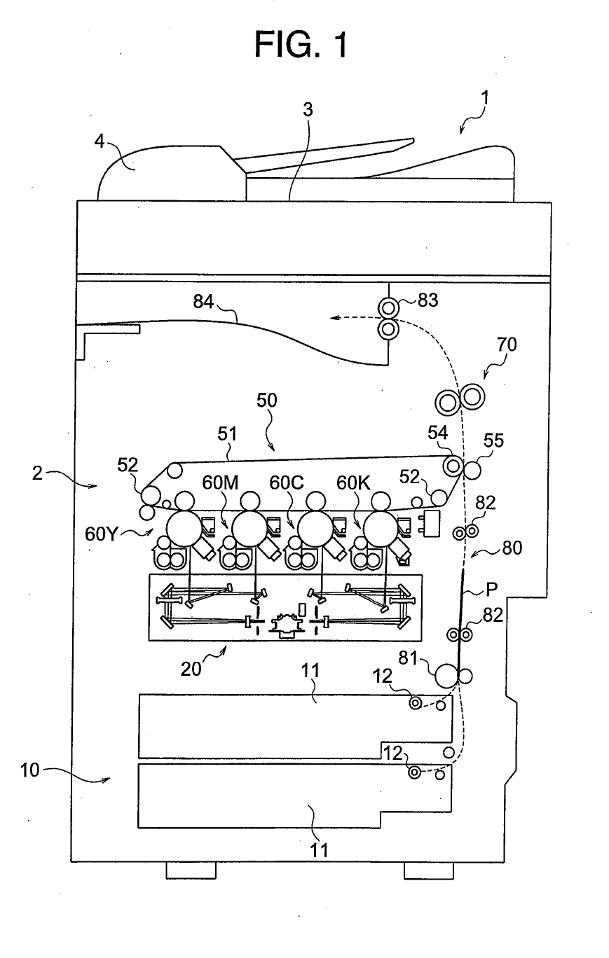

FIG. 1 is a longitudinal sectional view of a color multi function peripheral (MFP) 1, which is an image forming apparatus, according to a first embodiment. The MFP 1 includes a print section 2, a scanner section 3, and a document feeding section.

The print section 2 includes a paper feeding section 10, a laser optical unit 20, an image forming section 50, a fuser 70, and a conveying section 80.

The paper feeding section 10 includes plural paper feeding cassettes 11 that store sheets P stacked in a laminated shape and pickup rollers 12 that feed the sheets P, which are recording media, at the top layers of the sheets stored in the paper feeding cassettes 11 to the image forming section 50.

The image forming section 50 includes four image forming stations 60Y, 60M, 60C, and 60K for Y (yellow), M (magenta), C (cyan), and K (black), an intermediate transfer belt 51 onto which toner images formed by the image forming stations 60Y, 60M, 60C, and 60K are transferred, plural rollers 52 for applying predetermined tension to the intermediate transfer belt 51, and a driving roller 54 for driving the intermediate transfer belt 51. Further, the image forming section 50 includes a transfer roller 55, which is a transfer device. A part of the intermediate transfer belt 51 is arranged between the driving roller 54 and the transfer roller 55.

The conveying section 80 includes a registration roller 81 that starts conveyance of the sheet P let out from the pickup rollers 12 to the image forming section 50 at predetermined timing and plural conveying rollers 82 that convey the sheet P let out from the registration roller 81. The conveying section 80 includes a paper discharge roller 83 just before a position where the sheet P is discharged to the outside of the print section 2. A paper discharge tray 84 that receives the sheet P discharged by the paper discharge roller 83 is formed on the upper surface of the print section 2.

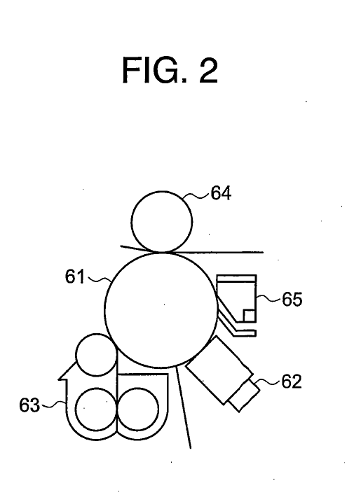

Next, an enlarged view of one image forming station 60 is shown in FIG. 2.

The image forming station 60 includes a photoconductive member 61 on which light emitted from the laser optical unit 20 is irradiated, a charging device 62 that applies uniform charges to the photoconductive member 61, a developing device 63 that stores a toner on the inside and supplies the toner to the photoconductive member 61, an intermediate transfer roller 64 that transfers the toner supplied to the photoconductive member 61 onto the intermediate transfer belt 51, and a cleaning unit 65 that cleans the toner remaining on the photoconductive member 61 without being transferred onto the intermediate transfer belt 51. All the image forming stations 60Y, 60M, 60C, and 60K have the same configuration.

Action of image formation is explained.

The charging device 62 applies uniform charges to the photoconductive member 61. On the photoconductive member 61 applied with the uniform charges, a latent image is formed by the light emitted from the laser optical unit 20. The developing device 63 supplies the toner to the photoconductive member 61 and forms a toner image on the photoconductive member 61. The toner image formed on the photoconductive member 61 by the developing device 63 is transferred onto the intermediate transfer belt 51 by the intermediate transfer roller 64.

The sheet P let out from the paper feeding cassettes 11 by the pickup rollers 12 is conveyed by the plural conveying rollers 82. When the sheet P reaches the transfer roller 55, the toner image formed on the intermediate transfer belt 51 is transferred onto the sheet P. The sheet P having the image transferred thereon is further conveyed. The image is fixed on the sheet P by the fuser 70. The sheet P having the image fixed thereon is discharged to the paper discharge tray 84.

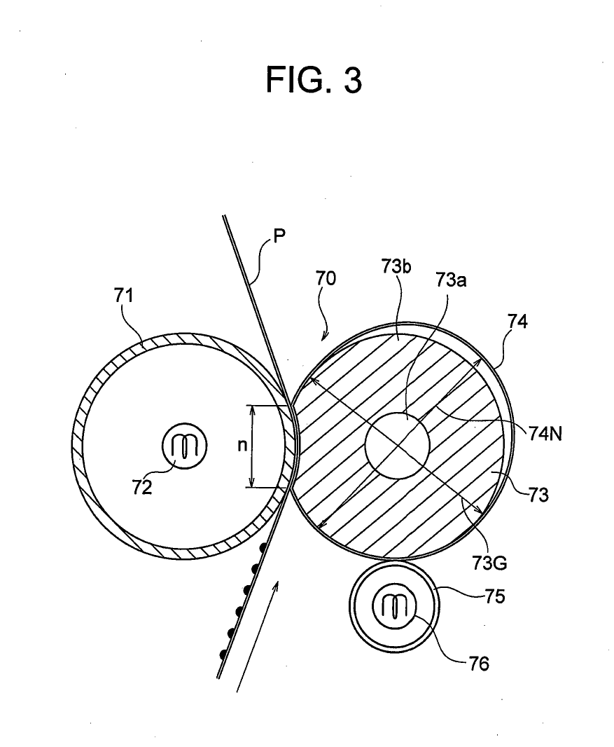

Next, the fuser 70 according to the first embodiment is explained in detail below with reference to FIG. 3.

The fuser 70 includes a heating roller 71, a pressing roller 73, and an endless belt 74. Further, the fuser 70 includes a heating roller side heater 72, a pressing side heating roller 75, and a pressing side heater 76.

The heating roller 71 is made of a metal hollow pipe. The heating roller side heater 72 is arranged on the inside of the heating roller 71. Both end sides of the hollow pipe are closed. Not-shown gears are provided at the ends. The rotation center axis of the gears coincides with the center of the hollow pipe. The heating roller side heater 72 is provided in the center position of the hollow pipe, i.e., the rotation axis of the gears. The gears provided at the ends of the heating roller 71 are connected to a not-shown motor. The heating roller 71 is not limited to the hollow pipe. An elastic member such as rubber may be wound around the outer circumferential surface of a component having a cylindrical shape, the ends of which are closed. In order to protect the outer circumferential surface of the rubber, a sheet having hardness higher than the hardness of the rubber may be wound around the rubber.

The pressing roller 73 includes a rotating shaft 73a made of metal and rubber 73b wound around the rotating shaft 73a. The diameter of the rotating shaft 73a is smaller than the thickness of the rubber 73b. Both ends of the rotating shaft 73a are supported by not-shown plates and are not connected to a driving source such as a motor. The pressing roller 73 is formed as a driven roller. The hardness of the rubber 73b is lower than the hardness of the heating roller 71. Therefore, when force is applied from the pressing roller 73 side to the heating roller 71 side, the pressing roller 73 side is deformed.

The endless belt 74 is made of polyimide resin or a metal material such as nickel or stainless steel. A part of the endless belt 74 is present between the heating roller 71 and the pressing roller 73 and is in contact with both of the heating roller 71 and the pressing roller 73 to form a pressing region n. The pressing region n serves as nip width as well.

An inner diameter 74N of the endless belt 74 is smaller than an outer diameter 73G of the pressing roller 73. A space of predetermined size is present between the endless belt 74 and the pressing roller 73. Since the material of the endless belt 74 and the material of the pressing roller 73 are different, the space of the predetermined size present between the endless belt 74 and the pressing roller 73 needs to be determined at a temperature for fixing a toner image on the sheet P. Since the inner diameter 74N of the endless belt 74 is smaller than the outer diameter 73G of the pressing roller 73, the inner circumference of the endless belt 74 is longer than the outer circumference of the pressing roller 73. A difference between the inner circumferential length of the endless belt 74 and the outer circumferential length of the pressing roller 73 is desirably small. The inner circumferential length of the endless belt 74 only has to not exceed 1.5 times the outer circumferential length of the pressing roller 73. The endless belt 74 only includes the pressing roller 73, rotates with friction of the pressing region n, and does not specifically include a member that supports the endless belt 74. Therefore, if the inner circumferential length of the endless belt 74 exceeds 1.5 times the outer circumferential length of the pressing roller 73, the rotation of the endless belt 74 is hindered. In this embodiment, if the inner circumferential length of the endless belt 74 is equal to or smaller than 1.5 times the outer circumferential length of the pressing roller 73, the inner circumferential length of the endless belt 74 and the outer circumferential length of the pressing roller 73 are defined as the same degree.

The pressing roller 73 and the endless belt 74 are in contact with a position opposed to the heating roller 71. Therefore, the position of the rotating shaft 73a of the pressing roller 73 and the position of the center of the endless belt 74 are different. As the space of the predetermined size formed between the endless belt 74 and the pressing roller 73, a largest space portion is formed in a position on the opposite side of a direction of the contact of the endless belt 74 and the pressing roller 73 with respect to the rotating shaft 73a and further on a downstream side than the rotating shaft 73a with respect to a conveying direction of the sheet P.

Since the endless belt 74 rotates following the heating roller 71, across section of the endless belt 74 in a direction orthogonal to the rotating shaft 73a is desirably a circular cross section. A cross section of the endless belt 74 in a direction orthogonal to the rotating direction does not need to be a circular cross section. However, in this embodiment, it is assumed that the cross section of the endless belt 74 in the direction orthogonal to the rotating shaft 73a is also a circular cross section. Since the inner circumferential length of the endless belt 74 and the outer circumferential length of the pressing roller 73 are different and the endless belt 74 and the pressing roller 73 are in contact with each other in the pressing region n, the rotating shaft 73a of the pressing roller 73 and an imaginary rotating shaft of the endless belt 74 are in a relation of different positions.

The hardness of the endless belt 74 is higher than the hardness of the pressing roller 73. The hardness of the endless belt 74 is lower than the hardness of the heating roller 71. Therefore, if pressure is applied from the pressing roller 73 side to the endless belt 74 side, the pressing roller 73 side is deformed. If pressure is applied from the endless belt 74 side to the heating roller 71 side, the endless belt 74 side is deformed. Therefore, if pressure is applied from the pressing roller 73 side to the heating roller 71 side, the pressing roller 73 is deformed along the shape of the heating roller 71.

The diameter of the pressing roller 73 is the same size as the diameter of the heating roller 71. However, the diameter of the pressing roller 73 is not limited to this and may be set larger than the diameter of the heating roller 71. If the diameter of the pressing roller 73 is set larger than the diameter of the heating roller 71, there is an advantage that a long distance can be secured as the pressing region n with respect to the conveying direction of the sheet P.

The pressing side heating roller 75 is arranged in the lower end position of the pressing roller 73 and is in contact with the outer circumference of the endless belt 74. The inner circumference of the endless belt 74 in a position where the outer circumference of the endless belt 74 and the pressing side heating roller 75 are in contact with each other is in contact with the outer circumference of the pressing roller 73. The position where the outer circumference of the endless belt 74 and the pressing side heating roller 75 are in contact with each other is not limited to the lower end position of the pressing roller 73 and only has to be on the pressing region n side than the lower end position of the rotating shaft 73a with respect to the rotating direction of the pressing roller 73. The pressing side heater 76 is provided on the inside of the pressing side heating roller 75 and heats the endless belt 74. The endless belt 74 has a role of transmitting heat received from the pressing side heater 76 to the pressing region n. The pressing side heating roller 75 may have a heat value smaller than the heat value of the heating roller side heater 72.

Action of fixing in the first embodiment is explained below.

The heating roller 71 is heated by the heating roller side heater 72. The endless belt 74 is heated by the pressing side heater 76. The pressing roller 73 is pressed to the heating roller 71 side at predetermined pressure.

The sheet P having the toner transferred thereon by the transfer device 55 and having the toner image formed thereon is conveyed to the fuser 70. At this point, a surface side on which the toner image is formed is opposed to the heating roller 71. The heating roller 71 is driven by the motor connected to the heating roller 71 and the pressing roller 73 rotates following the heating roller 71. The endless belt 74 rotates with friction of the heating roller 71 and the pressing roller 73. If it is determined on the basis of conveyance timing that the leading end of the sheet P reaches the vicinity of the pressing region n, the heating roller side heater 72 and the pressing side heater 76 change to an energized state and the heating roller 71 and the endless belt 74 are heated. The toner on the sheet P passed through the heating region n is fused and fixed on the sheet P by the heating roller 71 and the pressing roller 73.

In the first embodiment, only the pressing roller 73 is arranged in the space formed on the inside of the endless belt 74. Therefore, the number of components of the fuser 70 can be reduced and the structure of the fuser 70 can be simplified.

The pressing side heating roller 75 is in contact with the outer circumference of the endless belt 74 in the lower end position of the pressing roller 73, which is the position where the inner circumference of the endless belt 74 and the pressing roller 73 are in contact with each other. Therefore, the endless belt 74 can be moved to the pressing region n in a state in which the slack of the endless belt 74 is eliminated. Therefore, the contact position of the endless belt 74 and the pressing side heating roller 75 is desirably a position closer to the pressing region n. The space between the inner side of the endless belt 74 and the pressing roller 73 is formed small or very small. Therefore, the endless belt 74 present between the inlet to the pressing region n and the portion of the pressing side heating roller 75 is maintained at fixed tension by the lifting action due to the driving of the heating roller 71 and the resistance of rotation of the endless belt 74 held between the pressing roller 73 and the pressing side heating roller 75.

The diameter of the pressing roller 73 is set larger than the diameter of the heating roller 71. This makes it possible to secure, concerning the pressing region n that forms the nip width, the large distance in the sheet conveying direction.

### Second Embodiment

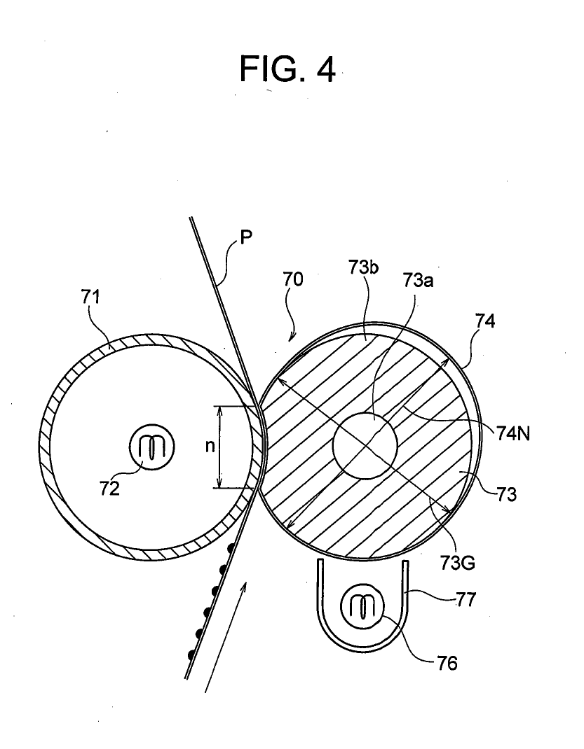

A fuser according to a second embodiment is explained with reference to FIG. 4. Explanation of components same as the components explained in the first embodiment in structure and action is omitted. The components are denoted by the same reference numerals and signs. Since the heating roller 71, the heating roller side heater 72, the pressing roller 73, and the endless belt 74 are the same as those in the first embodiment, explanation thereof is omitted.

In the second embodiment, in the fuser 70, a reflector 77 is provided instead of the pressing side heating roller 75. The reflector 77 is arranged in the lower end position of the pressing roller 73. The arrangement position of the reflector 77 is not limited to the lower end position of the pressing roller 73 and only has to be further on the pressing region n side than the lower end position of the rotating shaft 73a with respect to the rotating direction of the pressing roller 73. The reflector 77 is formed in a U shape. An opening of the reflector 77 is opposed to the endless belt 74. The pressing side heater 76 is arranged in a recessed portion of the reflector 77 having the U shape and heats the endless belt 74.

Since there is no device that is in contact with the endless belt 74 at the lower end thereof, unlike the first embodiment, the inner circumferential side of the endless belt 74 and the pressing roller 73 are not in contact with each other. The slack of the endless belt 74 occurs because of the own weight of the endless belt 74. If the circumferential length of the endless belt 74 is large, it is likely that the reflector 77 or the pressing side heating roller 75 arranged in the lower end position of the pressing roller 73 or further on the heating roller 71 side than the lower end position of the pressing roller 73 is in contact with the endless belt 74. Therefore, the inner diameter 74N of the endless belt 74, the outer diameter 73G of the pressing roller 73, and a distance of minimum length from pressing roller 73 to the reflector 77 or minimum length from the pressing roller 73 to the pressing side heater 76 are desirably in a relation of the following expression:

2S>π(D−d)

where, S represents the distance of the minimum length from pressing roller 73 to the reflector 77 or the minimum length from the pressing roller 73 to the pressing side heater 76, D represents the inner diameter 74N of the endless belt 74, and d represents the outer diameter 73G of the pressing roller 73.

Therefore, a difference between the inner circumferential length of the endless belt 74 and the outer circumferential length of the pressing roller 73 cannot be set as large as the difference in the first embodiment. The difference between the inner circumferential length of the endless belt 74 and the outer circumferential length of the pressing roller 73 needs to be very small.

Action in the second embodiment is the same as the action in the first embodiment. Therefore, explanation of the action is omitted.

According to the second embodiment, the fuser 70 includes the pressing side heater 76 but does not include the pressing side heating roller 75. Therefore, the fuser 70 does not need to include a bearing for rotating and supporting the pressing side heating roller 75 and the number of components is reduced. Since the pressing side heating roller 75 is not in contact with the endless belt 74, it is unlikely that contamination on the outer circumferential surface of the pressing side heating roller 75 is transferred onto the endless belt 74. It is also unlikely that contamination of the endless belt 74 based on contamination due to the transfer by the pressing side heating roller 75 is transferred onto a sheet on which a toner image is fixed.

In the embodiments (the first and second embodiments), the examples of the color image forming apparatus are explained. However, the embodiments are not limited to the color image forming apparatus and may be applied to a monochrome image forming apparatus. The embodiments may be realized as a standalone printer rather than the digital multi function peripheral. A decolorable toner may be used as the toner and may be used for either fusing action or decoloring action. The decolorable toner may be used for only the decoloring action without being used for the fusing action. In this embodiment, the decoloring action may be defined as being included in the fusing action.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and their equivalents are intended to cover such forms of modifications as would fall within the scope and spirit of the invention.

What is claimed is:

1. A fuser comprising:
a heating roller that rotates and comes into contact with a toner surface side of a sheet to heat the sheet;
an endless belt having hardness lower than hardness of the heating roller; and
a pressing roller that is an only rotating body provided in a space formed by the endless belt and having an outer diameter smaller than inner diameter of the endless belt, the pressing roller having hardness lower than the hardness of the heating roller and pressing the heating roller via a part of the endless belt.

2. The fuser according to claim 1, wherein the pressing roller is in contact with the endless belt in a direction in which the pressing roller is opposed to the heating roller.

3. The fuser according to claim 2, wherein the pressing roller has harness lower than the hardness of the endless belt.

4. The fuser according to claim 2, wherein a surface of the pressing roller is rubber.

5. The fuser according to claim 2, wherein the endless belt is made of polyimide resin.

6. The fuser according to claim 2, wherein the pressing roller includes a rotating shaft in a position different from a position of a rotating shaft of the endless belt.

7. The fuser according to claim 2, wherein the pressing roller has a diameter equal to or larger than a diameter of the heating roller.

8. The fuser according to claim 2, further comprising a pressing side heating roller that heats the endless belt, the pressing side heating roller being provided in a direction of a pressing region from a lower part in a vertical direction of the endless belt.

9. The fuser according to claim 8, wherein inner circumferential length of the endless belt is equal to or smaller than 1.5 times outer circumferential length of the pressing roller.

10. The fuser according to claim 8, wherein the pressing side heating roller includes a pressing side heater on an inside thereof.

11. The fuser according to claim 8, wherein the pressing side heating roller is in contact with the endless belt and is arranged in a lower end position of the pressing roller or further on the heating roller side than the lower end position of the pressing roller.

12. The fuser according to claim 2, further comprising a heating roller side heater that heats the heating roller.

13. The fuser according to claim 11, wherein the heating roller side heater is arranged on an inside of the heating roller.

14. An image forming apparatus comprising:
plural photoconductive members on which latent images are formed;
a developing device that supplies developers to the photoconductive members and form toner images on the photoconductive members;
a transfer device that transfers the toner images formed on the photoconductive members by the developing device onto a sheet;
a heating roller provided further on a downstream side in a sheet conveying direction than the transfer device and that rotates and comes into contact with a toner surface side of the sheet to heat the sheet; and
an endless belt having hardness lower than hardness of the heating roller; and
a pressing roller that is an only rotating body provided in a space formed by the endless belt and having an outer diameter smaller than inner diameter of the endless belt, the pressing roller having hardness lower than the hardness of the heating roller and pressing the heating roller via a part of the endless belt.

15. The apparatus according to claim 14, wherein the pressing roller is in contact with the endless belt in a direction in which the pressing roller is opposed to the heating roller.

16. The apparatus according to claim 15, wherein the pressing roller includes a rotating shaft in a position different from a position of a rotating shaft of the endless belt.

17. The apparatus according to claim 15, wherein the pressing roller has a diameter equal to or larger than a diameter of the heating roller.

18. The apparatus according to claim 15, wherein the pressing side heating roller is in contact with the endless belt and is arranged in a lower end position of the pressing roller or further on the heating roller side than the lower end position of the pressing roller.
